(19) United States
(12) Patent Application Publication
(10) Pub. No.: US 2024/0201148 A1
(43) Pub. Date: Jun. 20, 2024

(54) METHOD AND SYSTEM FOR COMPOUND DETERMINATION BY MASS SPECTROMETRY

(71) Applicant: SHIMADZU CORPORATION, Kyoto (JP)

(72) Inventor: Yuki ITO, Kyoto-shi (JP)

(73) Assignee: SHIMADZU CORPORATION, Kyoto (JP)

(21) Appl. No.: 18/518,273

(22) Filed: Nov. 22, 2023

(30) Foreign Application Priority Data
Dec. 19, 2022 (JP) 2022-201988

(51) Int. Cl. G01N 30/72; G01N 30/86; G01N 30/88

(52) U.S. Cl. CPC G01N 30/7233; G01N 30/8631; G01N 30/88

(57) ABSTRACT

Mass spectrometry data is acquired by performing a scan measurement over a predetermined m/z range on a sample by a mass spectrometer (11). Based on the data, whether or not predetermined compounds are contained in the sample is determined (14). A dataset is created in which the mass spectrometry data, and information identifying already-determined compounds are related to an ID of the sample (16). The datasets created for a plurality of samples are accumulated to construct a database. From this database, a dataset related to a re-determination target sample included in the plurality of samples is read. For each of re-determination target compounds including a compound which is none of the already-determined compounds, whether or not the compound concerned was contained in the re-determination target sample is determined based on the mass spectrometry data included in the dataset.

### TECHNICAL FIELD

The present invention relates to a method and system for compound determination by mass spectrometry.

### BACKGROUND ART

In recent years, simultaneous multicomponent analyses using a mass spectrometer have been commonly performed in various areas, such as the testing of residual agricultural chemicals in foods, the testing of contaminants in environmental water, or the testing of drugs and toxicants.

In these types of simultaneous multicomponent analyses, information concerning a large number of compounds that may possibly be contained in samples is previously registered in a database (compound library). Based on data acquired by a mass spectrometric analysis of a sample, each of the compounds registered in the compound library (or compounds designated from the library by a user) is subjected to a determination on whether or not the compound is contained in the sample.

In this type of simultaneous multicomponent analysis, a multiple reaction monitoring (MRM) measurement using a tandem mass spectrometer, such as a triple quadrupole mass spectrometer, is often performed (for example, see Patent Literature 1). A tandem mass spectrometer includes: an ion source which ionizes a sample; a front mass separator which performs selection of ions generated in the ion source, based on their m/z (mass-to-charge ratio); a collision cell in which an ion (precursor ion) that has passed through the front mass separator is fragmented: a rear mass separator which performs selection of product ions produced in the collision cell, based on their m/z; and a detector which detects an ion that has passed through the rear mass separator. In an MRM measurement, the m/z of the ion to be allowed to pass through is fixed in each of the front and rear mass separators in order to measure the intensity of a specific product ion generated from a specific precursor ion. In the MRM measurement, since ions originating from non-measurement-target components or foreign components, as well as neutral particles which have not been ionized, are removed by the front and rear mass separators in two stages, an ion intensity signal with a high signal-to-noise ratio can be obtained even in a simultaneous analysis of a sample containing a plurality of target components or an analysis of a sample containing a considerable amount of foreign components.

### CITATION LIST

### Patent Literature

Patent Literature 1: JP 2018-136266 A
Patent Literature 2: WO 2018/008149 A (paragraphs 0003 and 0004)

### SUMMARY OF INVENTION

### Technical Problem

In the previously described simultaneous multicomponent analysis, after an analysis of a sample by an MRM measurement was already completed, it may be newly found that a compound which was not expected at the time of the analysis of the sample was possibly mixed in the sample, or it may become necessary to determine whether or not a compound which has been newly designated as a regulated substance was contained in the sample. However, in the MRM measurement, after the completion of an analysis of a sample, it is impossible to determine whether or not a compound which had not been expected before was contained in the sample, since the combination of the m/z of the ion to be allowed to pass through the front mass separator and the m/z of the ion to be allowed to pass through the rear mass separator (this combination is called the “MRM transition”) is previously set for each compound to be tested, and the ion intensity signal is acquired for each MRM transition.

The present invention has been developed in view of the previously described point. Its objective is to make it possible to easily determine whether or not a specific compound was contained in a sample even when the determination concerning this specific compound has been newly required after the determination on whether or not predetermined compounds were contained in that sample was already completed.

### Solution to Problem

A method for compound determination by mass spectrometry according to the present invention developed for solving the previously described problem includes:
a mass spectrometry process for acquiring mass spectrometry data by performing a scan measurement over a predetermined m/z range on a determination-target sample by a mass spectrometer;
a determination process for determining, for each of one or more compounds, whether or not the compound is contained in the determination-target sample, based on the mass spectrometry data;
a dataset creation process for creating a dataset in which the mass spectrometry data, and information identifying already-determined compounds which are the one or more compounds, are related to information identifying the determination-target sample;
a database construction process for performing the mass spectrometry process, the determination process and the dataset creation process, using each of a plurality of samples as the determination-target sample, and for constructing a database by accumulating the dataset respectively created for each of the plurality of samples; and
a re-determination process for reading, from the database, the dataset related to a sample to be subjected to re-determination among the plurality of samples, and for determining, for each of re-determination target compounds, whether or not the re-determination target compound was contained in the sample to be subjected to the re-determination, based on the mass spectrometry data included in the dataset, where the re-determination target compounds are one or more compounds including a compound which is none of the already-determined compounds identified from the dataset.

A system for compound determination by mass spectrometry according to the present invention developed for solving the previously described problem includes:
a determiner configured to determine, for each of one or more compounds, whether or not the compound is contained in a determination-target sample, based on mass spectrometry data acquired by performing a scan measurement over a predetermined m/z range on the determination-target sample by a mass spectrometer;
a database registerer configured to record the mass spectrometry data and information identifying already-determined compounds which are the one or more compounds, in a database in which the mass spectrometry data and the information identifying the already-determined compounds are related to information identifying the determination-target sample; a re-determination-target-sample designation receiver configured to receive, from a user, a designation of a sample to be subjected to re-determination among a plurality of determination-target samples registered in the database;
a re-determination-target-compound designation receiver configured to receive, from a user, a designation of re-determination target compounds which are one or more compounds to be subjected to the re-determination;
a non-determined-compound identifier configured to read, from the database, the information identifying the already-determined compounds recorded for the sample to be subjected to the re-determination, and to identify one or more non-determined compounds which are compounds included in the re-determination target compounds and not included in the already-determined compounds; and
a re-determiner configured to read, from the database, the mass spectrometry data recorded for the sample to be subjected to the re-determination, and to determine, for each of the non-determined compounds, whether or not the non-determined compound was contained in the sample to be subjected to the re-determination, based on the mass spectrometry data.

Another system for compound determination by mass spectrometry according to the present invention developed for solving the previously described problem includes:
a determiner configured to determine, for each of one or more compounds, whether or not the compound is contained in a determination-target sample, based on mass spectrometry data acquired by performing a scan measurement over a predetermined m/z range on the determination-target sample by a mass spectrometer;
a database registerer configured to record the mass spectrometry data and information identifying already-determined compounds which are the one or more compounds, in a database in which the mass spectrometry data and the information identifying the already-determined compounds are related to information identifying the determination-target sample;
a re-determination-target-sample designation receiver configured to receive, from a user, a designation of a sample to be subjected to re-determination among a plurality of determination-target samples registered in the database;
a re-determination-target-compound designation receiver configured to receive, from a user, a designation of re-determination target compounds which are one or more compounds to be subjected to the re-determination;
a re-determiner configured to read, from the database, the mass spectrometry data recorded for the sample to be subjected to the re-determination, and to determine, for each of the re-determination target compounds, whether or not the re-determination target compound was contained in the sample to be subjected to the re-determination, based on the mass spectrometry data,
where:
the re-determination-target-compound designation receiver is configured to read, from the database, the information identifying the already-determined compounds recorded for the sample to be subjected to the re-determination, and to prevent the already-determined compounds from being designated by the user as the re-determination target compounds.

Still another system for compound determination by mass spectrometry according to the present invention developed for solving the previously described problem includes:
a determiner configured to determine, for each of one or more compounds, whether or not the compound is contained in a determination-target sample, based on mass spectrometry data acquired by performing a scan measurement over a predetermined m/z range on the determination-target sample by a mass spectrometer;
a database registerer configured to record the mass spectrometry data and information identifying already-determined compounds which are the one or more compounds, in a database in which the mass spectrometry data and the information identifying the already-determined compounds are related to information identifying the determination-target sample;
a re-determination-target-sample designation receiver configured to receive, from a user, a designation of a sample to be subjected to re-determination among a plurality of the determination-target samples recorded in the database;
an already-determined-compound presenter configured to read, from the database, information identifying the already-determined compounds recorded for the sample to be subjected to the re-determination, and to present the information to a user;
a re-determination-target-compound designation receiver configured to receive, from a user, a designation of re-determination target compounds which are one or more compounds to be subjected to re-determination; and
a re-determiner configured to read, from the database, the mass spectrometry data recorded for the sample to be subjected to the re-determination, and to determine, for each of the re-determination target compounds, whether or not the re-determination target compound was contained in the sample to be subjected to the re-determination, based on the mass spectrometry data.

### Advantageous Effects of Invention

By the method and system for compound determination by mass spectrometry according to the present invention, it is possible to easily determine whether or not a specific compound was contained in a sample even when the determination concerning this specific compound has been newly required after the determination on whether or not predetermined compounds were contained in that sample was once performed.

### BRIEF DESCRIPTION OF DRAWINGS

FIG. 1 is a block diagram showing the configuration of the main components of a compound determination system according to one embodiment of the present invention.

FIG. 2 a flowchart showing a procedure for sample determination using the aforementioned compound determination system.

FIG. 3 is a flowchart showing a procedure for sample re-determination using the aforementioned compound determination system.

FIG. 4 is a table showing the first half of a list of determination target compounds in one example of the present invention.

FIG. 5 is a table showing the second half of the list of determination target compounds.

FIG. 6 is an extracted ion chromatogram concerning the aforementioned determination target compounds.

FIG. 7 is a table showing a re-determination target compound in the aforementioned example.

FIG. 8 is an extracted ion chromatogram concerning the aforementioned re-determination target compound.

### DESCRIPTION OF EMBODIMENTS

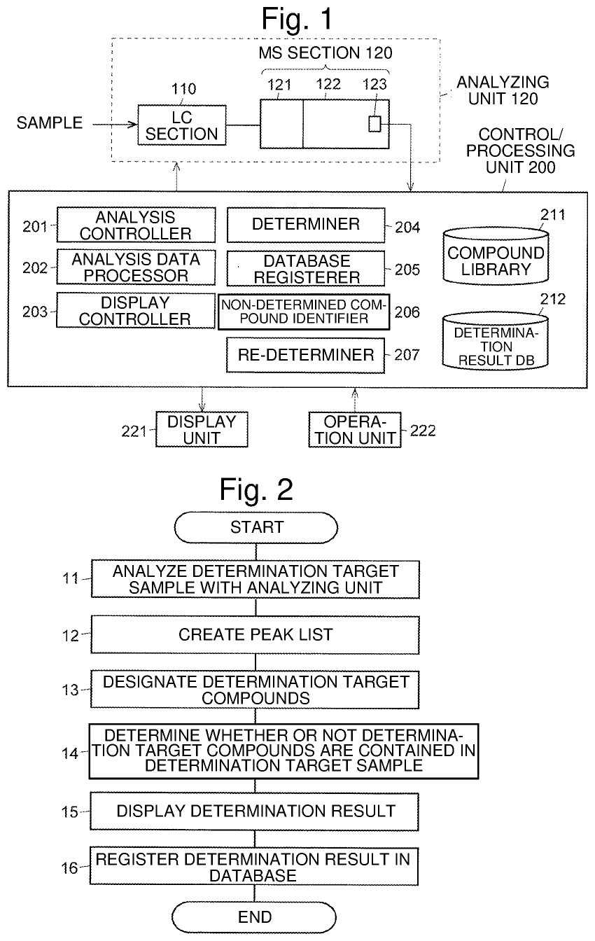

One mode for carrying out the present invention is hereinafter described with reference to the drawings. FIG. 1 is a block diagram showing the configuration of the main components of a compound determination system (which is hereinafter simply called the “system”) according to the present embodiment. The present system includes an analyzing unit 100 which performs an analysis of a sample, and a control/processing unit 200 which controls the operation of the analyzing unit 100 as well as processes data acquired through the analysis.

The analyzing unit 100 includes an LC section 110 configured to perform fractionation of a sample by high performance liquid chromatography (HPLC) and an MS section 120 which is a mass spectrometer. The MS section 120 includes an ionizer 121 configured to ionize components in a sample, a mass separator 122 configured to separate the ionized sample components according to their m/z, and a detector 123 configured to detect the separated ions. The mass spectrometer acting as the MS section 120 may be any type of mass spectrometer capable of a scan measurement, although it is preferable to use a high-resolution mass spectrometer whose mass-resolving power M/dM is equal to or higher than 10000 (where M is the m/z of a peak in a mass spectrum and dM is a half-value width of the peak). For example, a time-of-flight mass spectrometer (TOF-MS) or quadrupole time-of-flight mass spectrometer (QTOF-MS) can be suitably used as the aforementioned type of mass spectrometer. An orbitrap mass spectrometer or Fourier transform mass spectrometer (FTMS) can also be used.

The control/processing unit 200 consists of a multipurpose computer (such as a personal computer) or a dedicated computer, or their combination. This unit includes, as its functional blocks, an analysis controller 201, analysis data processor 202, display controller 203, determiner 204, database registerer 205, non-determined-compound identifier 206, and re-determiner 207. Basically, all of these functional blocks are functional means realized on a software basis by a CPU provided in the computer acting as the control/processing unit 200, by loading a dedicated program installed on a storage unit which is a hard disk drive (HDD), solid state drive (SSD) or similar large-volume storage device, into a memory of the computer and executing the same program. A display unit 221 including a liquid display device (or the like), and an operation unit 222 including a keyboard or mouse (or the like) are connected to the control/processing unit 200.

Furthermore, the control/processing unit 200 is provided with a compound library 211 and a determination result database 212 (which corresponds to the database in the present invention). The compound library 211 and the determination result database 212 may be provided on a storage device built in the computer acting as the control/processing unit 200, or they may be provided on a storage device connected to the computer directly or via a data communication network (e.g., LAN). They may also be located on another computer system accessible from the aforementioned computer via the Internet, i.e., on a storage device in the cloud computing.

In the compound library 211, a set of information is recorded beforehand for each of a plurality of compounds, being related to information which identifies a compound (e.g., compound name or structural formula), where each set of information includes at least the retention time and a peak list including peak information (m/z and intensity information) concerning one or more peaks to be observed in a mass spectrum of the compound concerned. The mass spectrum may be acquired by an actual measurement or by a theoretical calculation based on the structural information of the compound.

The system according to the present embodiment and the compound determination method employing the same system can be suitably used for simultaneous multicomponent analyses in such areas as the testing of residual agricultural chemicals in foods, the testing of contaminants in the environment, or the screening of drugs, toxicants or metabolites in blood or urine (e.g., doping test).

A procedure for determining, by means of the present system, whether or not predetermined compounds (which are hereinafter called the “determination target compounds”) are contained in a target sample (which is hereinafter called the “determination target sample”) is hereinafter described with reference to the flowchart in FIG. 2.

Initially, a determination target sample is introduced into the analyzing unit 100, and the separation of the sample components by the LC section 110 and the mass spectrometric analysis by the MS section 120 are performed (Step 11). The operations of the LC unit 110 and the MS unit 120 in this step are controlled by the analysis controller 201. The various components in the determination target sample introduced into the LC section 110 are separated from each other by a column (not shown) provided in the LC section 110 and exit from the exit end of the column with different time lags. The various components sequentially exiting from the column are introduced into the MS section 120, in which those components are ionized in the ionizer 121 and introduced into the mass separator 122. In the mass separator 122, the m/z of the ion to be allowed to pass through the mass separator 122 is varied to repeatedly scan a previously determined m/z range, and an ion which has passed through the mass separator 122 is detected by the detector 123. In summary, in the MS section 120, a scan measurement over a predetermined m/z range is repeatedly performed for various components in the determination target sample sequentially introduced with the passage of time. The detection signals produced by the detector 123 during this process are sent to the analysis data processor 202 in the control/processing unit 200 via an analogue-to-digital converter (not shown). The previously described scan measurement is a normal scan measurement with no fragmentation of ions. There is no specific limitation on the m/z range to be scanned in the measurement. For example, it may be m/z 50-1500 (preferably, m/z 100-1000).

Based on the data (mass spectrometry data) acquired through the analysis of the determination target sample by the analyzing unit 100, the analysis data processor 202 creates a mass spectrum in each scan measurement, and further creates a peak list based on this mass spectrum (Step 12). That is to say, the analysis data processor 202 creates a mass spectrum with m/z and ion intensity as the dimensions, based on the data acquired through the scan measurement in the mass separator 122, and subsequently detects one or more peaks in the mass spectrum to create a peak list which lists the m/z values and ion intensities of the peaks. The present step may be performed after the completion of the analysis of the determination target sample by the analyzing unit 100 (Step 11), or in parallel with the same analysis.

Subsequently, the user performs a predetermined operation using the operation unit 222. Then, a screen for designating determination target compounds (determination-target-compound designation screen) is displayed on the display unit 221 under the control of the display controller 203. The determination-target-compound designation screen is configured to allow for the selection of one or more compounds from a plurality of compounds registered in the compound library 211. The user selects one or more compounds through the operation unit 222, whereby those compounds are designated as the determination target compounds (Step 13). The description thus far has assumed that the designation of the determination target compounds (Step 13) is performed after the analysis of the determination target sample by the analyzing unit 100 (Step 11) and the creation of the peak list by the analysis data processor 202 (Step 12). Alternatively, the designation of the determination target compounds may be performed before the analysis of the determination target sample and the creation of the peak list.

Next, for each of the determination target compounds, whether or not the compound is contained in the determination target sample is determined by the determiner 204 (Step 14). Specifically, for one of the one or more determination target compounds designated in Step 13, the retention time and the peak list of the determination target compound are read from the compound library 211. This peak list is compared with a peak list acquired in the vicinity of the retention time among the peak lists created for the determination target sample in Step 12, to determine the degree of similarity between the two peak lists. If the degree of similarity is equal to or higher than a previously determined threshold, it is concluded that the determination target compound concerned is contained in the determination target sample.

After the previously described determination process has been completed for all of the determination target compounds designated in Step 13, a screen which shows the determination result (i.e., the presence or absence of each determination target compound in the determination target sample) is displayed on the display unit 221 under the control of the display controller 203 (Step 15).

Furthermore, the database registerer 205 creates a dataset for the designation target sample and registers it in the determination result database 212 (Step 16). The dataset includes the following items of information related to information for identifying the determination target sample (e.g., the name or ID number of the sample): all peak lists created for the determination target sample in Step 12; information identifying each determination target compound whose presence or absence in the determination target sample was determined, i.e., each determination target compound designated in Step 13 (e.g., compound name); and the determination result in Step 14. The information for identifying the determination target sample (which is hereinafter called the “sample ID”) may be manually entered by the user in the present step. Alternatively, the system may be configured to allow the user to enter this information at a point in time earlier than the present step, e.g., before the analysis of the determination target sample by the analyzing unit 100 (Step 11) or when designating the determination target compound (Step 13).

By performing the processes from Steps 11 through 16 with various samples as the determination target samples and accumulating the acquired datasets in the determination result database 212, a database concerning various samples for which the determination was already made is constructed.

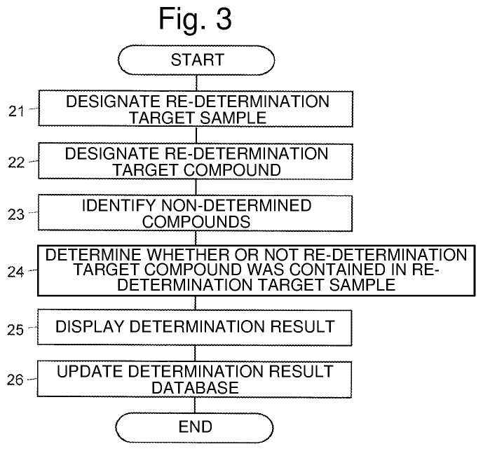

Next, with reference to the flowchart in FIG. 3, a procedure is hereinafter described which is performed, using the present system, for a sample for which the presence or absence of predetermined compounds was already determined (this type of sample is hereinafter called the “already-determined sample”), in order to determine whether or not a specific compound, which is none of those predetermined compounds, was contained in the sample (this determination is hereinafter called the “re-determination”).

Initially, the user performs a predetermined operation using the operation unit 222, whereby a re-determination-target-sample designation screen is displayed on the display unit 221 under the control of the display controller 203. For example, the re-determination-target-sample designation screen is configured to be capable of receiving an input of a sample ID from users. By operating the operation unit 222, the user designates a sample to be subjected to the re-determination (which is hereinafter called the “re-determination target sample”) on this screen (Step 21). That is to say, in the present step, the display controller 203, display unit 221 and operation unit 222 function as the re-determination-target-sample designation receiver in the present invention. The user enters a desired sample ID on the re-determination-target-sample designation screen. This sample ID is used in a query for searching the determination result database 212 to retrieve a plurality of peak lists related to the already-determined sample corresponding to the sample ID and information which identifies compounds whose presence or absence in the already-determined sample was already determined (those compounds are hereinafter called the “already-determined compounds”). The re-determination-target-sample designation screen may alternatively be configured to show a list of sample IDs related to already-determined samples registered in the determination result database 212, and to allow users to select one of them as the re-determination target sample.

Next, the user performs a predetermined operation using the operation unit 222, whereby a re-determination-target-compound designation screen is displayed on the display unit 221 under the control of the display controller 203. The re-determination-target-compound designation screen is configured to allow users to select one or more compounds from a plurality of compounds registered in the compound library 211. By operating the operation unit 222, the user designates one or more compounds to be subjected to the re-determination (those compounds are hereinafter called the “re-determination target compounds”) on this screen (Step 22). That is to say, in the present step, the display controller 203, display unit 221 and operation unit 222 function as the re-determination-target-compound designation receiver in the present invention.

Subsequently, the non-determined-compound identifier 206 identifies one or more compounds which are not already-determined compounds (those compounds are hereinafter called the “non-determined compounds”) among the re-determination target compounds designated in Step 22 (Step 23). If there was no non-determined compound, a message describing the situation is displayed on the display unit 221, and the entire processing sequence is discontinued. If there is one or more non-determined compounds, the re-determiner 207 determines, for each of the non-determined compounds, whether or not the non-determined compound was contained in the re-determination target sample (Step 24). Specifically, for one of the one or more non-determined compounds identified in Step 23, the retention time and the peak list related to the non-determined compound are read from the compound library 211, and the peak list is compared with a peak list acquired in the vicinity of the retention time among the peak lists of the determination target sample read in Step 21, to determine the degree of similarity between the two peak lists. If the degree of similarity is equal to or higher than a previously determined threshold, it is concluded that the re-determination target compound was contained in the re-determination target sample.

After the previously described determination process has been completed for all of the non-determined compounds identified in Step 23, a screen which shows the determination result (i.e., the presence or absence of each non-determined compound in the re-determination target sample) is displayed on the display unit 221 under the control of the display controller 203 (Step 25)

Furthermore, the database registerer 205 updates the determination result database 212 by adding the information identifying the re-determination target compound and the result of the re-determination, to the dataset recorded in the determination result database 212 and related to the sample ID of the re-determination target sample designated in Step 21 (Step 26).

A description of a mode for carrying out the present invention has been given thus far, providing a specific example. The present invention is not limited to the previously described embodiment, which is allowed to be appropriately changed or modified within the spirit of the present invention. For example, the system according to the previously described embodiment is configured to separate various components in the determination target sample from each other by a liquid chromatograph (LC section 110) and introduce them into the MS section 120. In place of the liquid chromatograph, a different type of chromatograph (e.g., gas chromatograph), or a separation device which is not a chromatograph, may be used for the separation of sample components. As another possible configuration, such a separation device may be omitted, and the determination target sample may be directly introduced into the MS section 120 by an infusion method (or the like).

The mass spectrometry data in the present invention is not limited to the previously described type of peak list but may be any type of data that represents the intensities of ions within a predetermined m/z range, acquired by a scan measurement with no fragmentation of ions. For example, it may be profile data with no peak extraction process performed. For example, in the previously described embodiment, peak lists created for a determination target sample are related to the sample ID of the determination target sample and registered in the determination result database 212 in Step 16. In place of those peak lists, profile data concerning the determination target sample may be registered.

In the previously described embodiment, the determination in Steps 14 and 24 is performed in such a manner that a peak list related to a determination target sample or re-determination target sample (which may be hereinafter collectively called a “target sample”) and a peak list related to a determination target compound (or non-determined compound) are compared to determine whether nor not the determination target compound (or non-determined compound) is (or was) contained in the target sample based on the degree of similarity between the two peak lists. Alternatively, profile data related to the target sample and profile data related to the determination target compound (or non-determined compound) registered in the compound library beforehand may be compared to perform the determination based on the degree of similarity between the two pieces of profile data. As another possibility, the m/z of ions representative of various compounds (those ions are hereinafter called the “representative ions”) may be registered in the compound library, and the determination may be made based on whether or not the peak of the representative ion of the determination target compound (or non-determined compound) is present in the profile data or peak list related to the target sample.

Still another possibility is as follows: For each of the various compounds, the retention time and the m/z of a representative ion are registered in the compound library 211. In the determination in Steps 14 and 24, the analysis data processor 202 creates an extracted ion chromatogram for the representative m/z for each determination target compound (or non-determined compound) based on the data acquired through the analysis by the analyzing unit 100, i.e., the three-dimensional data with m/z, intensity and time as the dimensions. In that case, in each extracted ion chromatogram created for the representative m/z of each determination target compound, whether or not a peak having an intensity equal to or higher than a predetermined level is present within a predetermined time range before and after the retention time of the determination target compound (or non-determined compound) can be determined. If such a peak has been located, it can be concluded that the determination target compound is (or was) contained in the target sample, and if no such peak has been located, it can be concluded that the determination target compound is not (was not) contained in the target sample.

Still another possibility is as follows: The retention time, m/z of a plurality of representative ions, and reference value of the intensity ratio of those representative ions (e.g., peak area ratio or peak height ratio) are registered for each of the various compounds in the compound library 211. In the analysis data processor 202, based on the previously mentioned three-dimensional data, an extracted ion chromatogram is created for each of the m/z of the representative ions of the determination target compound (or non-determined compound) within a predetermined time range around the retention time of the determination target compound (or non-determined compound), and the determination is made based on the extracted ion chromatograms (for example, see Patent Literature 2). In that case, peak detection is initially performed for each extracted ion chromatogram, and the intensity value (e.g., area value or height value) of each detected peak is determined. From the intensity value of the peak determined for each extracted ion chromatogram, the intensity ratio of the representative ions in the target sample is calculated, and this ratio is compared with the reference value of the intensity ratio of the representative ions related to the determination target compound (or non-determined compound) registered in the compound library 211. If the difference between the two ratios is included within a previously determined allowable range, it is concluded that the determination target compound (or non-determined compound) is (or was) contained in the target sample. If the difference is not included within the allowable range, it is concluded that the determination target compound (or non-determined compound) is not (or was not) contained in the target sample.

In the previously described embodiment, the non-determined-compound identifier 206 identifies non-determined compounds, i.e., the compounds which are not already-determined compounds among the re-determination target compounds designated by the user in Step 22, and only those non-determined compounds are subjected to the determination in Step 24 (i.e., the re-determination). In place of providing the non-determined-compound identifier 206, the system may be configured to prevent the already-determined compounds from being selected by users on the re-determination-target-compound designation screen displayed in Step 22. In that case, for example, the system can be configured to display, on the re-determination-target-compound designation screen, only the compounds which are not the already-determined compounds among the compounds registered in the compound library 211, allowing the user to select compounds to be subjected to the re-determination from the displayed compounds. As another possibility, all compounds registered in the compound library 211 may be displayed on the re-determination-target-compound designation screen, on which the already-determined compounds are disabled from being selected by users.

It is also possible to make the determination on whether or not a compound was contained in a re-determination target sample for all compounds designated as the re-determination target compounds by the user in Step 22, regardless of whether or not the compound in question is an already-determined compound. Even in this case, it is preferable to show, on the display unit 221, the information identifying the already-determined compounds related to the re-determination target sample, as information for helping users in designating the re-determination target compounds (in this case, the display controller 203 and the display unit 221 function as the already-determined-compound presenter in the present invention).

### EXAMPLE

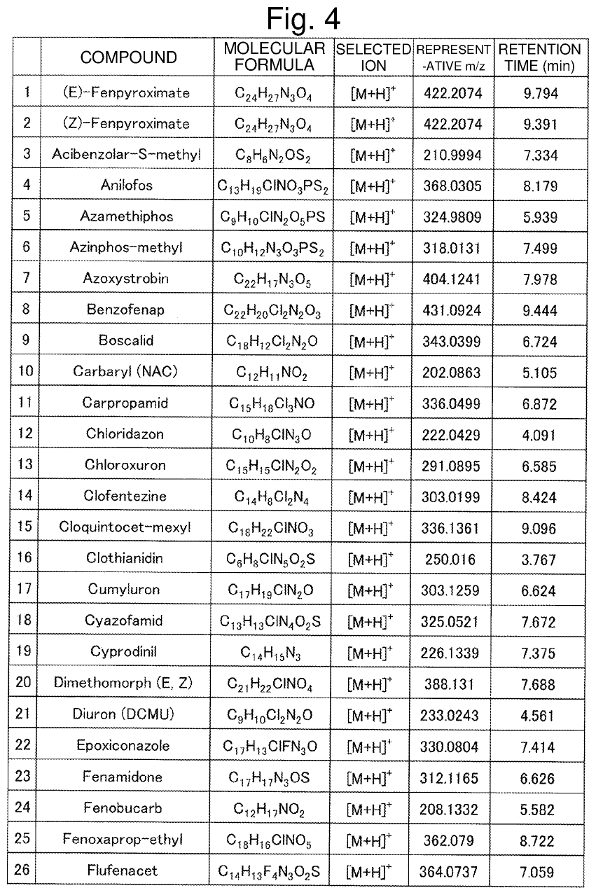

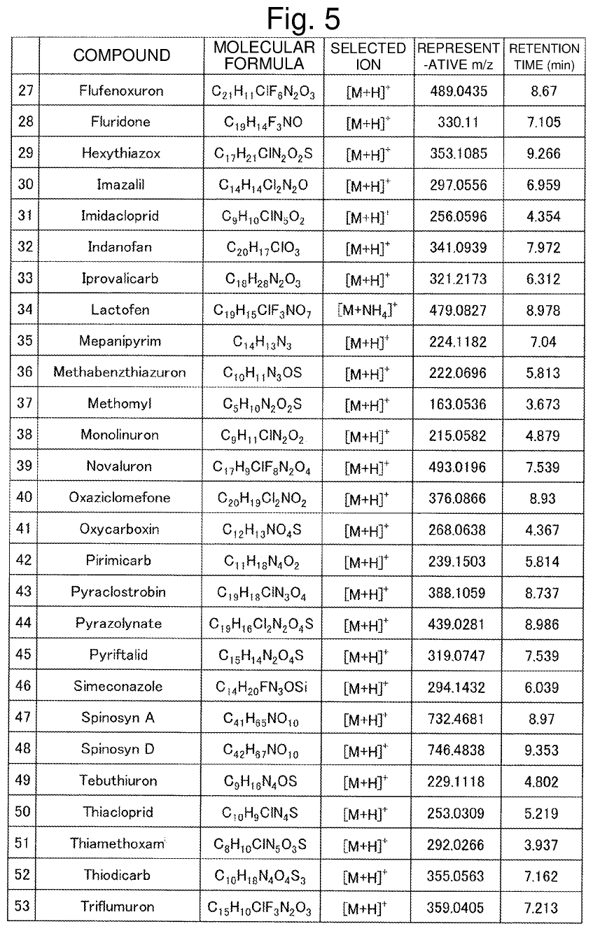

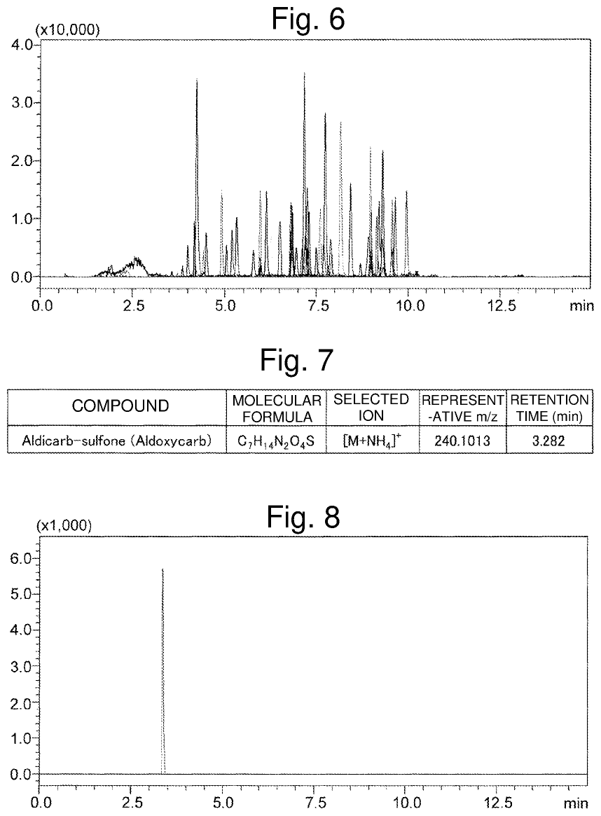

An example concerning the present invention is hereinafter described with reference to FIGS. 4-8. In the present example, an extract of an agricultural product (strawberry) was used as the determination target sample, and whether or not the 53 compounds (agricultural chemicals) shown in FIGS. 4 and 5 were contained in the determination target sample was determined. For this determination, a scan analysis of the determination target sample was performed with a liquid chromatograph mass spectrometer, and an extracted ion chromatogram was created for the representative m/z of each compound based on the acquired three-dimensional data having the dimensions of m/z, intensity and time. FIG. 6 shows the extracted ion chromatograms superposed on each other. Each of the extracted ion chromatograms has a peak located at or around the retention time of the corresponding compound. Thus, it was confirmed that all of the 53 compounds were contained in the determination target sample.

At a later point in time, an extracted ion chromatogram at a representative m/z of a compound which was not included in the 53 aforementioned compounds was created based on the aforementioned three-dimensional data which had been saved. The compound was specifically Aldicarb-sulfone (Aldoxycarb) shown in FIG. 7. FIG. 8 shows the extracted ion chromatogram. This extracted ion chromatogram has a peak located at or around the retention time of Aldicarb-sulfone (i.e., 3.282 min). This fact confirmed that Aldicarb-sulfone was also contained in the determination target sample in addition to the 53 aforementioned compounds.

### [Modes]

It is evident for a person skilled in the art that the previously described illustrative embodiment is a specific example of the following modes of the present invention.

(Clause 1) A method for compound determination by mass spectrometry according to one mode of the present invention includes:
a mass spectrometry process for acquiring mass spectrometry data by performing a scan measurement over a predetermined m/z range on a determination-target sample by a mass spectrometer;
a determination process for determining, for each of one or more compounds, whether or not the compound is contained in the determination-target sample, based on the mass spectrometry data;
a dataset creation process for creating a dataset in which the mass spectrometry data, and information identifying already-determined compounds which are the one or more compounds, are related to information identifying the determination-target sample;
a database construction process for performing the mass spectrometry process, the determination process and the dataset creation process, using each of a plurality of samples as the determination-target sample, and for constructing a database by accumulating the dataset respectively created for each of the plurality of samples; and
a re-determination process for reading, from the database, the dataset related to a sample to be subjected to re-determination among the plurality of samples, and for determining, for each of re-determination target compounds, whether or not the re-determination target compound was contained in the sample to be subjected to the re-determination, based on the mass spectrometry data included in the dataset, where the re-determination target compounds are one or more compounds including a compound which is none of the already-determined compounds identified from the dataset.

In the method for compound determination by mass spectrometry according to Clause 1, a scan measurement of a determination target sample is performed with a mass spectrometer, and whether or not each of one or more determination target compounds is contained in the determination target sample is determined based on the result of the scan measurement. Scan measurements can acquire mass spectrometry data without previously limiting the compounds to be detected. Therefore, even after the completion of the mass spectrometric analysis and the determination, it is possible to determine (re-determine), based on the mass spectrometry data acquired through the scan analysis, whether or not a compound that was not expected at the time of the determination was contained in the determination target sample. Furthermore, in the method for compound determination by mass spectrometry according to Clause 1, the mass spectrometry data acquired through a scan analysis of each of a plurality of samples, and information concerning compounds for which the determination using each piece of mass spectrometry data was already completed (already-determined compounds), are recorded in a database, so that the re-determination can be easily performed by retrieving the information of the samples for which the user performed the determination in the past.

(Clause 2) In a method for compound determination by mass spectrometry according to Clause 2, which is a method according to Clause 1, the re-determination target compounds in the re-determination process include only compounds which are not the already-determined compounds.

In the method for compound determination by mass spectrometry according to Clause 2, the already-determined compounds are excluded from the target of the re-determination. This reduces the computation load in the re-determination process and shortens the period of time required for the re-determination.

(Clause 3) In a method for compound determination by mass spectrometry according to Clause 3, which is a method according to Clause 1 or 2, the mass-resolving power of the mass spectrometer is equal to or higher than 10000.

In the method for compound determination by mass spectrometry according to Clause 3, highly accurate compound determination (and re-determination) with little influence from foreign components in a sample (or other factors) can be realized by performing the scan measurement with high mass-resolving power.

(Clause 4) A system for compound determination by mass spectrometry according to Clause 4 includes:
a determiner configured to determine, for each of one or more compounds, whether or not the compound is contained in a determination-target sample, based on mass spectrometry data acquired by performing a scan measurement over a predetermined m/z range on the determination-target sample by a mass spectrometer;
a database registerer configured to record the mass spectrometry data and information identifying already-determined compounds which are the one or more compounds, in a database in which the mass spectrometry data and the information identifying the already-determined compounds are related to information identifying the determination-target sample; a re-determination-target-sample designation receiver configured to receive, from a user, a designation of a sample to be subjected to re-determination among a plurality of determination-target samples registered in the database;
a re-determination-target-compound designation receiver configured to receive, from a user, a designation of re-determination target compounds which are one or more compounds to be subjected to the re-determination;
a non-determined-compound identifier configured to read, from the database, the information identifying the already-determined compounds recorded for the sample to be subjected to the re-determination, and to identify one or more non-determined compounds which are compounds included in the re-determination target compounds and not included in the already-determined compounds; and
a re-determiner configured to read, from the database, the mass spectrometry data recorded for the sample to be subjected to the re-determination, and to determine, for each of the non-determined compounds, whether or not the non-determined compound was contained in the sample to be subjected to the re-determination, based on the mass spectrometry data.

In the re-determination of a sample for which the determination was already made in the past, if the compounds designated by the user include a compound for which the determination was already made, the system for compound determination by mass spectrometry according to Clause 4 automatically excludes that compound from the target of the re-determination. Therefore, the situation in which the re-determination is performed for already-determined compounds can be avoided, which reduces the computation load in the re-determination process and decreases the period of time required for the re-determination.

(Clause 5) A system for compound determination by mass spectrometry according to Clause 5 includes:
a determiner configured to determine, for each of one or more compounds, whether or not the compound is contained in a determination-target sample, based on mass spectrometry data acquired by performing a scan measurement over a predetermined m/z range on the determination-target sample by a mass spectrometer;
a database registerer configured to record the mass spectrometry data and information identifying already-determined compounds which are the one or more compounds, in a database in which the mass spectrometry data and the information identifying the already-determined compounds are related to information identifying the determination-target sample;
a re-determination-target-sample designation receiver configured to receive, from a user, a designation of a sample to be subjected to re-determination among a plurality of determination-target samples registered in the database;
a re-determination-target-compound designation receiver configured to receive, from a user, a designation of re-determination target compounds which are one or more compounds to be subjected to the re-determination;
a re-determiner configured to read, from the database, the mass spectrometry data recorded for the sample to be subjected to the re-determination, and to determine, for each of the re-determination target compounds, whether or not the re-determination target compound was contained in the sample to be subjected to the re-determination, based on the mass spectrometry data,
where:
the re-determination-target-compound designation receiver is configured to read, from the database, the information identifying the already-determined compounds recorded for the sample to be subjected to the re-determination, and to prevent the already-determined compounds from being designated by the user as the re-determination target compounds.

In the re-determination of a sample for which the determination was already made in the past, the system for compound determination by mass spectrometry according to Clause 5 can prevent already-determined compounds from being designated as targets of the re-determination. Therefore, the situation in which the re-determination is performed for already-determined compounds can be avoided, which reduces the computation load in the re-determination process and decreases the period of time required for the re-determination.

(Clause 6) A system for compound determination by mass spectrometry according to Clause 6 includes:
a determiner configured to determine, for each of one or more compounds, whether or not the compound is contained in a determination-target sample, based on mass spectrometry data acquired by performing a scan measurement over a predetermined m/z range on the determination-target sample by a mass spectrometer;
a database registerer configured to record the mass spectrometry data and information identifying already-determined compounds which are the one or more compounds, in a database in which the mass spectrometry data and the information identifying the already-determined compounds are related to information identifying the determination-target sample;
a re-determination-target-sample designation receiver configured to receive, from a user, a designation of a sample to be subjected to re-determination among a plurality of the determination-target samples recorded in the database;
an already-determined-compound presenter configured to read, from the database, information identifying the already-determined compounds recorded for the sample to be subjected to the re-determination, and to present the information to a user;
a re-determination-target-compound designation receiver configured to receive, from a user, a designation of re-determination target compounds which are one or more compounds to be subjected to re-determination; and
a re-determiner configured to read, from the database, the mass spectrometry data recorded for the sample to be subjected to the re-determination, and to determine, for each of the re-determination target compounds, whether or not the re-determination target compound was contained in the sample to be subjected to the re-determination, based on the mass spectrometry data.

In the re-determination of a sample for which the determination was already made in the past, the system for compound determination by mass spectrometry according to Clause 6 presents the user a piece of information concerning compounds whose presence or absence in the sample concerned was already determined. By referring this information, the user can easily designate compounds to be subjected to the re-determination.

### REFERENCE SIGNS LIST

100 . . . Analyzing Unit
110 . . . LC Section
120 . . . MS Section
200 . . . Control/Processing Unit
201 . . . Analysis Controller
202 . . . Analysis Data Processor
203 . . . Display Controller
204 . . . Determiner
205 . . . Database Registerer
206 . . . Non-Determined Compound Identifier
207 . . . Re-Determiner
211 . . . Compound Library
212 . . . Determination Result Database
221 . . . Display Unit
222 . . . Operation Unit

1. A method for compound determination by mass spectrometry, comprising:
a mass spectrometry process for acquiring mass spectrometry data by performing a scan measurement over a predetermined m/z range on a determination-target sample by a mass spectrometer;
a determination process for determining, for each of one or more compounds, whether or not the compound is contained in the determination-target sample, based on the mass spectrometry data;
a dataset creation process for creating a dataset in which the mass spectrometry data, and information identifying already-determined compounds which are the one or more compounds, are related to information identifying the determination-target sample;
a database construction process for performing the mass spectrometry process, the determination process and the dataset creation process, using each of a plurality of samples as the determination-target sample, and for constructing a database by accumulating the dataset respectively created for each of the plurality of samples; and
a re-determination process for reading, from the database, the dataset related to a sample to be subjected to re-determination among the plurality of samples, and for determining, for each of re-determination target compounds, whether or not the re-determination target compound was contained in the sample to be subjected to the re-determination, based on the mass spectrometry data included in the dataset, where the re-determination target compounds are one or more compounds including a compound which is none of the already-determined compounds identified from the dataset.

2. The method for compound determination by mass spectrometry according to claim 1, wherein the re-determination target compounds in the re-determination process include only compounds which are not the already-determined compounds.

3. The method for compound determination by mass spectrometry according to claim 1, wherein a mass-resolving power of the mass spectrometer is equal to or higher than 10000.

4. A system for compound determination by mass spectrometry, comprising:
a determiner configured to determine, for each of one or more compounds, whether or not the compound is contained in a determination-target sample, based on mass spectrometry data acquired by performing a scan measurement over a predetermined m/z range on the determination-target sample by a mass spectrometer;
a database registerer configured to record the mass spectrometry data and information identifying already-determined compounds which are the one or more compounds, in a database in which the mass spectrometry data and the information identifying the already-determined compounds are related to information identifying the determination-target sample;
a re-determination-target-sample designation receiver configured to receive, from a user, a designation of a sample to be subjected to re-determination among a plurality of determination-target samples registered in the database;
a re-determination-target-compound designation receiver configured to receive, from a user, a designation of re-determination target compounds which are one or more compounds to be subjected to the re-determination;
a non-determined-compound identifier configured to read, from the database, the information identifying the already-determined compounds recorded for the sample to be subjected to the re-determination, and to identify one or more non-determined compounds which are compounds included in the re-determination target compounds and not included in the already-determined compounds; and
a re-determiner configured to read, from the database, the mass spectrometry data recorded for the sample to be subjected to the re-determination, and to determine, for each of the non-determined compounds, whether or not the non-determined compound was contained in the sample to be subjected to the re-determination, based on the mass spectrometry data.

5. A system for compound determination by mass spectrometry, comprising:
a determiner configured to determine, for each of one or more compounds, whether or not the compound is contained in a determination-target sample, based on mass spectrometry data acquired by performing a scan measurement over a predetermined m/z range on the determination-target sample by a mass spectrometer;
a database registerer configured to record the mass spectrometry data and information identifying already-determined compounds which are the one or more compounds, in a database in which the mass spectrometry data and the information identifying the already-determined compounds are related to information identifying the determination-target sample;
a re-determination-target-sample designation receiver configured to receive, from a user, a designation of a sample to be subjected to re-determination among a plurality of determination-target samples registered in the database;
a re-determination-target-compound designation receiver configured to receive, from a user, a designation of re-determination target compounds which are one or more compounds to be subjected to the re-determination;
a re-determiner configured to read, from the database, the mass spectrometry data recorded for the sample to be subjected to the re-determination, and to determine, for each of the re-determination target compounds, whether or not the re-determination target compound was contained in the sample to be subjected to the re-determination, based on the mass spectrometry data,
where:
the re-determination-target-compound designation receiver is configured to read, from the database, the information identifying the already-determined compounds recorded for the sample to be subjected to the re-determination, and to prevent the already-determined compounds from being designated by the user as the re-determination target compounds.

6. A system for compound determination by mass spectrometry, comprising:
a determiner configured to determine, for each of one or more compounds, whether or not the compound is contained in a determination-target sample, based on mass spectrometry data acquired by performing a scan measurement over a predetermined m/z range on the determination-target sample by a mass spectrometer;
a database registerer configured to record the mass spectrometry data and information identifying already-determined compounds which are the one or more compounds, in a database in which the mass spectrometry data and the information identifying the already-determined compounds are related to information identifying the determination-target sample;
a re-determination-target-sample designation receiver configured to receive, from a user, a designation of a sample to be subjected to re-determination among a plurality of the determination-target samples recorded in the database;
an already-determined-compound presenter configured to read, from the database, information identifying the already-determined compounds recorded for the sample to be subjected to the re-determination, and to present the information to a user;
a re-determination-target-compound designation receiver configured to receive, from a user, a designation of re-determination target compounds which are one or more compounds to be subjected to re-determination; and
a re-determiner configured to read, from the database, the mass spectrometry data recorded for the sample to be subjected to the re-determination, and to determine, for each of the re-determination target compounds, whether or not the re-determination target compound was contained in the sample to be subjected to the re-determination, based on the mass spectrometry data.
